(19) United States
(12) Patent Application Publication
(10) Pub. No.: US 2025/0117883 A1
(43) Pub. Date: Apr. 10, 2025

(54) IMAGE CORRECTION METHOD, ELECTRONIC DEVICE AND COMPUTER READABLE STORAGE MEDIUM

(71) Applicant: AMLOGIC (SHANGHAI) CO., LTD., Shanghai (CN)

(72) Inventors: Zhen Wang, Shanghai (CN); Linshui Wang, Shanghai (CN); Dongjian Wang, Shanghai (CN)

(21) Appl. No.: 18/793,995

(22) Filed: Aug. 5, 2024

(30) Foreign Application Priority Data
Oct. 9, 2023 (CN) 202311304825.8

(51) Int. Cl. G06T 5/00

(52) U.S. Cl. CPC G06T 5/00; G06T 2207/10024; G06T 2207/20076

(57) ABSTRACT

The present disclosure discloses an image correction method, an electronic device and a computer readable storage medium. The image correction method includes: obtaining an original image and a preset color adjustment strategy; obtaining pixel statistical information of the original image; determining a target color adjustment strategy based on the pixel statistical information and the preset color adjustment strategy; and adjusting the original image based on the target color adjustment strategy to obtain a target image with colors distinguishable by a user. The image correction method can adjust an original image through a target color adjustment strategy formed by different preset color adjustment strategies, so as to allow colors in the original image can be distinguished by a color-blind user. In addition, the color change in the original image is small, so as to improve the naturalness of the original image.

### CROSS REFERENCE OF RELATED APPLICATION

The application claims the priority of the Chinese patent application No. 202311304825.8 entitled “IMAGE CORRECTION METHOD, ELECTRONIC DEVICE AND COMPUTER READABLE STORAGE MEDIUM” and filed by Amlogic (Shanghai) Co., Ltd. on Oct. 9, 2023, which is hereby incorporated by reference in its entirety.

### TECHNICAL FIELD

The present disclosure relates to the field of electronic technology, more particularly to an image correction method, an electronic device and a computer readable storage medium.

### BACKGROUND

In related technologies, after a color-blind user selects a color blindness type in an existing electronic device, the electronic device can determine an initial color that cannot be recognized by the user based on the color blindness type and a target color that can be recognized by the user and that can be substituted for the initial color, establish a corresponding relationship between the initial color and the target color, and then adjust the original image based on the corresponding relationship between the initial color and the target color. However, the above method can only adjust a relatively single color of the original image, and causes a significant change to the original image using color replacement and thus causes a loss in naturalness of the original image.

### SUMMARY

The present disclosure aims to address at least one of the technical problems existing in the related art. Therefore, one purpose of the present disclosure is to propose an image correction method that can adjust an original image through a target color adjustment strategy formed by different preset color adjustment strategies, so as to allow colors in the original image can be distinguished by a color-blind user. In addition, the color change in the original image is small, so as to improve the naturalness of the original image.

A second purpose of the present disclosure is to propose an electronic device.

A third purpose of the present disclosure is to propose a computer readable storage medium.

In order to solve the above problems, an embodiment in a first aspect of the present disclosure provides an image correction method. The image correction method includes: obtaining an original image and a preset color adjustment strategy; obtaining pixel statistical information of the original image; determining a target color adjustment strategy based on the pixel statistical information and the preset color adjustment strategy; and adjusting the original image based on the target color adjustment strategy to obtain a target image with colors distinguishable by a user.

According to the image correction method in the embodiment of the present disclosure, multiple preset color adjustment strategies pre-stored in the electronic device are adjusted through the pixel statistical information of the original image to calculate and obtain the target color adjustment strategy. Instead of directly replacing colors in the original image that can not be recognized by the color-blind user, the target color adjustment strategy is a calculated sum of the multiple color adjustment strategies, and the color of each pixel in the original image is adjusted based on the target color adjustment strategy to obtain the original image with colors distinguishable by the color-blind user. Compared to the method of replacing the initial color in the existing electronic device, in the present disclosure, the target color adjustment strategy formed by different preset color adjustment strategies is used to adjust the original image, so that colors in the original image can be distinguished by the color-blind user, and the color change in the original image is small so as to improve the naturalness of the original image.

In some embodiments, the preset color adjustment strategy includes a first color adjustment strategy. The first color adjustment strategy is obtained by: obtaining coordinate information of a white point in u′v′ space, coordinate information of a pixel to be adjusted in the original image, and a first rotation angle value of the pixel to be adjusted; obtaining, based on the coordinate information of the white point and the coordinate information of the pixel to be adjusted, a first angle value between the pixel to be adjusted and the white point as well as a first distance value between the pixel to be adjusted and the white point; and obtaining adjusted coordinate information corresponding to the pixel to be adjusted in the original image based on the coordinate information of the white point, the first rotation angle value, the first angle value and the first distance value.

In some embodiments, the preset color adjustment strategy includes a second color adjustment strategy. The second color adjustment strategy is obtained by: performing color clustering on the original image to obtain a color class of pixels in the original image; obtaining coordinate information of a confusion point in u′v′ space, coordinate information of a pixel to be adjusted in each color class, and a second rotation angle value of the pixel to be adjusted; obtaining a second angle value of the pixel to be adjusted with respect to the confusion point and a second distance value from the pixel to be adjusted to the confusion point based on the coordinate information of the confusion point and the coordinate information of the pixel to be adjusted; and obtaining adjusted coordinate information corresponding to the pixel to be adjusted based on the coordinate information of the confusion point, the second rotation angle value, the second angle value, and the second distance value.

In some embodiments, the preset color adjustment strategy includes a third color adjustment strategy. The third color adjustment strategy is obtained by: obtaining a landing point of a pixel to be adjusted in the original image in u′v′ space; performing, based on color hue, color classification on the landing point to obtain a color class; obtaining coordinate information of a confusion point in u′v′ space, coordinate information of the pixel to be adjusted in each color class, and a third angle value of a preset confusion line corresponding to the color class in u′v′ space; obtaining a fourth angle value of the pixel to be adjusted in the color class with respect to the confusion point based on the coordinate information of the confusion point and the coordinate information of the pixel to be adjusted in the color class; obtaining a third rotation angle value of the pixel to be adjusted in the color class based on the third angle value and the fourth angle value; and obtaining adjusted coordinate information corresponding to the pixel to be adjusted in the color class based on the coordinate information of the confusion point, the third rotation angle value, the third angle value and the third distance value.

In some embodiments, the preset color adjustment strategy includes a fourth color adjustment strategy. The fourth color adjustment strategy is obtained by: obtaining a color blindness type of a color-blind user; obtaining, based on the color blindness type, first color information corresponding to the original image received by the color-blind user and second color information lost by the color-blind user in the original image; obtaining color compensation information based on the first color information and the second color information; and adjusting each pixel to be adjusted in the original image based on the color compensation information to obtain adjusted color information corresponding to the pixel to be adjusted.

In some embodiments, the obtaining the pixel statistical information of the original image includes: obtaining at least one of: a histogram of the original image in RGB space and a histogram of the original image in Luv space, coordinates and ranges of landing points of pixels of the original image in the Luv space, or a clustering result of the landing points of the pixels of the original image in the Luv space.

In some embodiments, the determining the target color adjustment strategy based on the pixel statistical information and the preset color adjustment strategy includes: determining a color distribution scene of the original image based on the pixel statistical information; determining a weight of the preset color adjustment strategy based on the color distribution scene; and obtaining the target color adjustment strategy based on the weight and the preset color adjustment strategy.

In some embodiments, the determining the weight of the preset color adjustment strategy based on the color distribution scene includes: obtaining coordinate information of landing points of pixels in the original image in the Luv space; determining a color gamut area of the Luv space and the number of landing points for different color types; calculating an area of the landing points based on the coordinate information of the landing points; determining an image color distribution based on the area of the landing points and the color gamut area; and determining the weight of the preset color adjustment strategy based on the image color distribution or the number of landing points.

In some embodiments, the obtaining the target color adjustment strategy based on the weight and the preset color adjustment strategy includes: multiplying a result obtained after adjusting pixels in the original image based on the preset color adjustment strategy with the weight corresponding to the preset color adjustment strategy; and determining a sum value of all the results obtained by the multiplication as the target color adjustment strategy.

In some embodiments, the image correction method further includes: obtaining a clustering result of the landing points of pixels of the original image in the Luv space; calculating brightness values of different colors within each cluster based on the clustering result; and adjusting brightness of pixels within each cluster based on the brightness values.

In some embodiments, the adjusting the brightness of pixels within each cluster based on the brightness values includes: determining a degree of difference between different colors within the cluster based on brightness values of the different colors within the cluster; determining a brightness adjustment amount based on the degree of difference; and adjusting the brightness values of corresponding pixels based on the brightness adjustment amount.

In some embodiments, the image correction method further includes: obtaining pixel statistical information of multiple frames including a current video frame and a previous video frame; determining whether the color distribution scene has changed based on the pixel statistical information of the multiple frames; and adjusting, if the color distribution scene changes, an image correction strategy of the current video frame based on the color distribution scene and an image correction strategy of the previous video frame. The image correction strategy includes a color adjustment strategy and a brightness adjustment strategy.

In some embodiments, the adjusting the image correction strategy of the current video frame based on the image correction strategy of the previous video frame includes: obtaining a reference weight of the image correction strategy of the previous video frame based on a difference value of the color distribution scene due to change thereof; and obtaining an adjusted image correction strategy of the current video frame based on the reference weight, the image correction strategy of the previous video frame, and the image correction strategy of the current video frame.

An embodiment in a second aspect of the present disclosure provides an electronic device including: at least one processor; and a memory in connection communication with at least one processor. The memory stores a computer program executable by the at least one processor, and the computer program when executed by the at least one processor, implements the image correction method described in any of the above embodiments.

The electronic device according to the embodiment of the present disclosure, by performing the image correction method of any embodiment as described above, can adjust an original image using the target color adjustment strategy formed based on multiple preset color adjustment strategies, so as to allow colors in the original image to be distinguished by a color-blind user. In addition, the color change in the original image is small, so as to improve the naturalness of the original image.

An embodiment in a third aspect of the present disclosure provides a computer readable storage medium having a computer program stored thereon. The computer program when executed, implements the image correction method according to any of the above embodiments.

Additional aspects and advantages of the present disclosure will be given in part in the following descriptions, become apparent in part from the following descriptions, or be learned from the practice of the disclosure.

### BRIEF DESCRIPTION OF DRAWINGS

The above and/or additional aspects and advantages of the present disclosure will become apparent and readily appreciated from the following description of embodiments, taken in conjunction with the accompanying drawings, in which:

FIG. 1 is a flowchart of an image correction method according to an embodiment of the present disclosure;

FIG. 2 is a schematic diagram of an RGB color gamut according to an embodiment of the present disclosure;

FIG. 3 is a schematic diagram of a first color adjustment strategy according to an embodiment of the present disclosure;

FIG. 4 is a schematic diagram of a second color adjustment strategy according to an embodiment of the present disclosure;

FIG. 5 is a schematic diagram of a third color adjustment strategy according to an embodiment of the present disclosure;

FIG. 6 is a flowchart of an image correction method according to another embodiment of the present disclosure;

FIG. 7 is a flowchart of an image correction method according to still another embodiment of the present disclosure;

FIG. 8 is a flowchart of an image correction method according to yet another embodiment of the present disclosure;

FIG. 9 is a structural block diagram of an electronic device according to an embodiment of the present disclosure.

### REFERENCE NUMERALS

Electronic device 10;
Processor 1; Memory 2.

### DESCRIPTION OF EMBODIMENTS

Embodiments of the present disclosure will be described in detail below, and the embodiments described with reference to the accompanying drawings are exemplary. Embodiments of the present disclosure will be described in detail below.

According to a survey, a proportion of male color-blind patients in China is in a range of 5% to 8%, and a proportion of female color-blind patients is in a range of 0.5% to 1%. It is easy for normal people to distinguish between colors. However, it is difficult for color-blind patients to distinguish between colors, causing many troubles in their daily lives. Therefore, it is crucial for an electronic device to have a function of adjusting a color of an image to be recognized by color-blind patients.

Humans rely on cone cells of the retina to receive signals with different wavelengths so as to distinguish between colors. The reason why color-blind patients cannot distinguish between colors is that their cone cells are damaged or that at least one type of cone cells are missed. Color blindness may be innate, or may be acquired. Color-blind patients are divided into patients of red color blindness, patients of green color blindness and patients of blue color blindness, having abnormal cone cells that receive long-wave signals, medium-wave signals and short-wave signals respectively.

In order to solve the above problems, an embodiment in a first aspect of the present disclosure provides an image correction method, which can adjust an original image through a target color adjustment strategy determined based on different preset color adjustment strategies, so as to allow a color-blind user to distinguish between colors in the original image. In addition, the method causes a minor change to the colors in the original image so as to improve the naturalness of the original image.

An image correction method according to an embodiment of the present disclosure is described below with reference to FIG. 1. As shown in FIG. 1, the method includes at least steps S1 to S3.

At Step 1, an original image and a preset color adjustment strategy are obtained.

Specifically, an electronic device obtains an original image that is stored in it or captured in real time, and obtains one or more preset color adjustment strategies pre-stored in the electronic device that are used for adjusting a color of the original image.

At Step 2, pixel statistical information of the original image is obtained.

Specifically, the electronic device obtains pixel statistical information of the original image. The pixel statistical information can be an overall color, brightness, and contrast of the original image, etc. The pixel statistical information is not limited to any of these examples.

At Step 3, a target color adjustment strategy is determined based on the pixel statistical information of the original image and the preset color adjustment strategy of the original image.

Specifically, each preset adjustment strategy is adjusted based on the pixel statistical information of the original image, such as the overall color, to calculate and obtain a target color adjustment strategy. Here, multiple preset color adjustment strategies are obtained based on the type of color blindness.

At Step 4, the original image is adjusted based on the target color adjustment strategy to obtain a target image with colors distinguishable by a user.

Specifically, in related technologies, after a color-blind user selects a color blindness type in an existing electronic device, the electronic device can determine an initial color that cannot be recognized by the color-blind user based on the color blindness type and a target color that can be recognized by the user and that can be substituted for the initial color, establish a corresponding relationship between the initial color and the target color, and then adjust the original image based on the corresponding relationship between the initial color and the target color. However, the above method can only adjust a relatively single color of the original image, and causes a significant change to the original image using color replacement and thus causes a loss in naturalness of the original image. In order to solve the above problems, in the present disclosure, after the color-blind user enters a color blindness type on the electronic device, the original image can be adjusted based on a target color adjustment strategy. The color blindness type can be red color blindness, green color blindness or blue color blindness. The target color adjustment strategy is a calculated sum of multiple color adjustment strategies. For example, the target color adjustment strategy is a calculated sum of multiple preset color compensation strategies, such as pixel rotation around a white point in the original image, pixel rotation around a confusion point, and RGB space color compensation. That is, the color of each pixel in the original image that can not be recognized by the color-blind user is adjusted using the target color adjustment strategy, instead of directly replacing colors in the original image that can not be recognized by the color-blind user, so as to obtain a target image with colors distinguishable by the user. For different original images with different overall colors (i.e., different pixel statistical information), in the present application, each preset adjustment strategy is adjusted based on the pixel statistical information and different target color adjustment strategies can be obtained through calculation, thus effectively achieving the differentiation among colors of the original image. Compared to the method of replacing the initial color in the existing electronic device, in the present disclosure, the target color adjustment strategy formed by different preset color adjustment strategies is used to adjust the original image, so that colors in the original image can be distinguished by the color-blind user, and the color change in the original image is small so as to improve the naturalness of the original image.

According to the image correction method in the embodiment of the present disclosure, multiple preset color adjustment strategies pre-stored in the electronic device are adjusted through the pixel statistical information of the original image to calculate and obtain the target color adjustment strategy. Instead of directly replacing colors in the original image that can not be recognized by the color-blind user, the target color adjustment strategy is a calculated sum of the multiple color adjustment strategies, and the color of each pixel in the original image is adjusted based on the target color adjustment strategy to obtain the original image with colors distinguishable by the color-blind user. Compared to the method of replacing the initial color in the existing electronic device, in the present disclosure, the target color adjustment strategy formed by different preset color adjustment strategies is used to adjust the original image, so that colors in the original image can be distinguished by the color-blind user, and the color change in the original image is small so as to improve the naturalness of the original image.

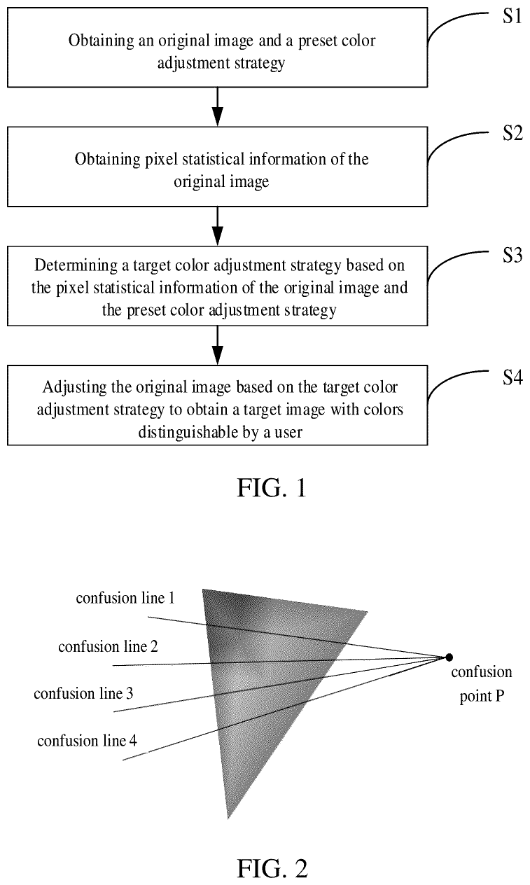

In an embodiment, for patients with different types of color blindness, there are different confusion points on the u′v′ plane. A line emitted from a confusion point is called a confusion line. A color-blind patient cannot distinguish between colors on the confusion line that have a same brightness. The red color blindness is taken as an example. As shown in FIG. 2, a confusion point on the coordinate system of the u′v′ plane is P (0.678, 0.501). If a line connecting two colors passes through the point and the two colors have a same brightness, the red-blind patient cannot distinguish between these two colors.

In some embodiments, the preset color adjustment strategy includes a first color adjustment strategy. The first color adjustment strategy is obtained by: obtaining coordinate information of a white point in u′v′ space, coordinate information of a pixel to be adjusted in the original image, and a first rotation angle value of the pixel to be adjusted; obtaining, based on the coordinate information of the white point and the coordinate information of the pixel to be adjusted, a first angle value between the pixel to be adjusted and the white point as well as a first distance value between the pixel to be adjusted and the white point; and obtaining adjusted coordinate information corresponding to the pixel to be adjusted in the original image based on the coordinate information of the white point, the first rotation angle value, the first angle value and the first distance value.

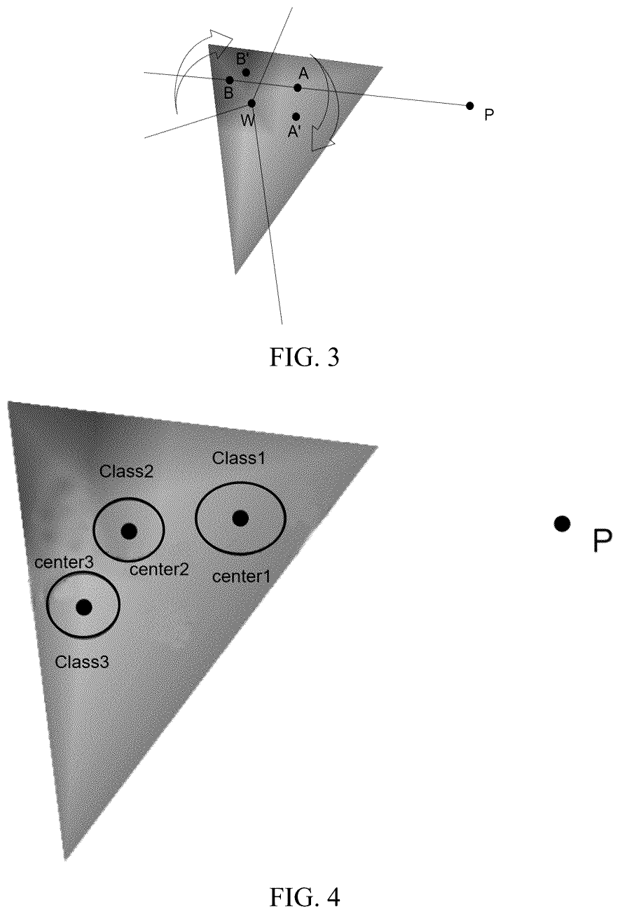

Specifically, the first color adjustment strategy refers to the strategy of rotating a pixel to be adjusted around a white point W, which is used in a case in which a proportion of blue in the original image is very small. An electronic device obtains coordinate information of a white point in u′v′ space, coordinate information of the pixel to be adjusted in the original image, and a first rotation angle value of the pixel to be adjusted. Here, the pixel to be adjusted in the original image refers to each pixel in the original image, and the first rotation angle value refers to an angle value of rotation of the pixels to be adjusted that are located in a same confusion line and that have different colors to different confusion lines according to requirements. The direction of rotation angle can be clockwise or counterclockwise. As shown in FIG. 3, a pixel B to be adjusted and a pixel A to be adjusted that have different colors are located on a same confusion line, the pixel B to be adjusted is rotated around a white point W to the position of B′, the pixel A to be adjusted is rotated around the white point W to the position of A′, and the adjusted pixel B′ and the adjusted pixel A′ are not located on the same confusion line, so that color-blind user can distinguish between red and green. Based on the coordinate information of the white point and the coordinate information of the pixel to be adjusted, the first angle value between the pixel to be adjusted and the white point is calculated, and the first distance value between the pixel to be adjusted and the white point is calculated. Then, based on the coordinate information of the white point, the first rotation angle value, the first angle value and the first distance value, the adjusted coordinate information corresponding to the pixel to be adjusted in the original image is obtained. That is, the coordinate information of the white point (u_{w}, v_{w}), the first rotation angle value Δθ1, the first angle value θₒᵣ₁, and the first distance value d1 are substitute in adjustment formulas for the pixel to be adjusted. The formulas are u_{new}=u_{w}+d·cos(θₒᵣ₁+Δθ1), and v_{new}=v_{w}+d1·sin(θₒᵣ₁+Δθ1), to calculate and obtain the adjusted coordinate information (u_{new}, v_{new}) corresponding to the pixel to be adjusted in the original image in the u′v′ space. Here, the adjusted coordinate information indicates the adjusted color of the pixel to be adjusted. Therefore, colors in the original image can be adjusted to colors that can be distinguished by the color-blind user. Therefore, by adjusting the color of the pixel to be adjusted in the original image through the first color adjustment strategy, it can achieve best distinction between red and green for the original image without blue color.

It should be noted that, among the first color adjustment strategies corresponding to different types of color blindness respectively, first rotation angle values Δθ1 for the pixel to be adjusted are different, and rotation directions thereof are different. Each first rotation angle value Δθ1 and the rotation direction thereof can be preset according to the type of color blindness. That is to say, for different color blindness types and for the same color hue, the first rotation angle values Δθ1 are different and rotation directions are different. That is, the first rotation angle values Δθ1 and rotation directions thereof that are corresponding to different color blindness types are preset based on color hue. Pixels in two different colors on the same confusion line are rotated by a first rotation angle value in a rotation direction, so that users of different color blindness types can distinguish the original image. Therefore, it can obtain the corresponding first color adjustment strategy based on the type of color blindness.

In some embodiments, the preset color adjustment strategy includes a second color adjustment strategy. The second color adjustment strategy is a strategy of rotating a pixel to be adjusted around a confusion point. The second color adjustment strategy is obtained by the following operations. Firstly, color clustering is performed on the original image to obtain a color class of pixels in the original image. For example, an electronic device uses an automatic clustering algorithm such as k-means clustering algorithm to cluster colors in the original image so as to obtain a color class of pixels in the original image. The color class can be a blue class, a red class, and a green class. For example, colors can be divided into color class 1, color class 2, and color class 3 as shown in FIG. 4, without limiting the number of color classes. Then, coordinate information of a confusing point in u′v′ space, coordinate information of a pixel to be adjusted in each color class and a second rotation angle value of the pixel to be adjusted are automatically obtained. For each pixel to be adjusted in the same color class, the second rotation angle value is the same and the rotation direction is also the same. For example, if some pixels to be adjusted in color class 1 and some pixels to be adjusted in color class 2 are on the same confusion line, the color class 1 is rotated clockwise around the confusion point, so as to allow the color-blind user to distinguish between colors in the original image. Based on the coordinate information of the confusion point and the coordinate information of the pixel to be adjusted, a second angle value of the pixel to be adjusted with respect to the confused point and a second distance value of the pixel to be adjusted to the confused point are obtained through calculation. It should be noted that the coordinates of the confusion points corresponding to different types of color blindness are different. Therefore, according to the type of color blindness, the corresponding adjustment parameters, namely the second angle value and the second distance value, can be obtained. Then, the coordinate information (uₚ, vₚ) of the confusion point, the second rotation angle value 462, the second angle value θₒᵣ₂, and the second distance value d2 are substituted into adjustment formulas for the pixel to be adjusted. The formulas are u_{new}=uₚ+d2·cos(θₒᵣ₂+Δθ2), and v_{new}=vₚ+d2·sin(θₒᵣ₂+Δθ2), to calculate and obtain the adjusted coordinate information (u_{new}, v_{new}) corresponding to the pixel to be adjusted in the u′v′ space. The adjusted coordinate information indicates the adjusted color of the pixel to be adjusted, so as to adjust the color in the original image to the color that can be distinguished by the color-blind user. Therefore, by adjusting the color of the pixel to be adjusted in the original image through the second color adjustment strategy, the change to the original image is small.

It should be noted that the coordinates of the confusion points corresponding to different types of color blindness are different. Therefore, the corresponding adjustment parameters obtained based on the color blindness types, that is, the second angle value and the second distance value, are different. Furthermore, the second rotation angle values are different and the rotation directions are different based on the color blindness types. Therefore, the coordinate information of the pixel to be adjusted after adjustment in the second color adjustment strategy is different among the different types of color blindness. That is, the adjustment results of the color of the pixel to be adjusted in the original image are different types of color blindness. In other words, the second color adjustment strategy is determined based on the color blindness type so as to allow different color-blind users to distinguish the original image.

In addition, the positions and ranges of individual classes, distances between the individual classes and arrangements of the individual classes that are determined based on the color clustering of the original image are different, and the second color adjustment strategies obtained are also different. If all classes are arranged along the direction of the confusion line, the second color adjustment strategy causes a large adjustment for each class.

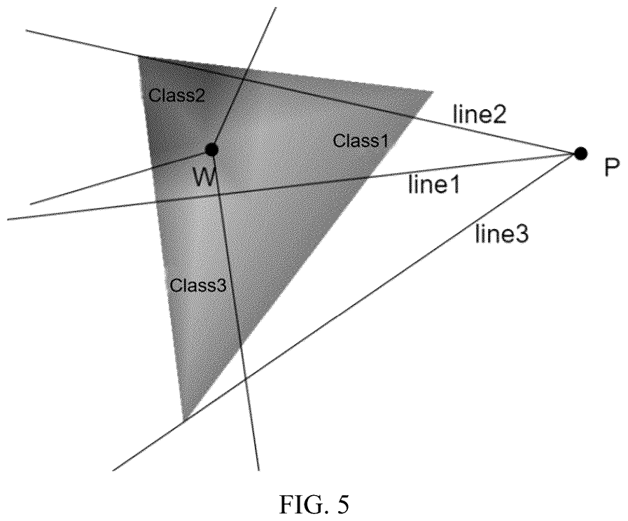

In some embodiments, the preset color adjustment strategy includes a third color adjustment strategy. The third color adjustment strategy is a strategy of rotating a pixel to be adjusted around a confusion point. The third color adjustment strategy is obtained through the following operations. To be specific, an electronic device obtains a landing point of the pixel to be adjusted in the original image in u′v′ space, and performs color classification on the landing point based on the color hue to obtain a color class. For example, the landing points on the u′v′ space is divided into red class 1, green class 2 and blue class 3 based on the color hue. That is, three straight lines starting from point W in FIG. 5 divide the landing points into three color classes, and can additionally divide the landing points into yellow class, cyan class and magenta class. The electronic device obtains coordinate information of the confusion point in u′v′ space, coordinate information of a pixel to be adjusted in each color class, and a third angle value of the preset confusion line corresponding to the color class in the u′v′ space. The third angle value is an angle between the preset confusion line and the positive direction of the u-axis, or an angle of the preset confusion line relative to the confusion point. Based on the coordinate information of the confusion point and the coordinate information of the pixel to be adjusted in the color class, a fourth angle value of the pixel to be adjusted in the color class with respect to the confusion point is obtained. The preset confusion line is a confusion line with the best color adjustment effect that is set based on experience. As shown in FIG. 5. The preset confusion line corresponding to red class 1 is line1, the preset confusion line corresponding to green class 2 is line2, and the preset confusion line corresponding to blue class 3 is line3. That is to say, the pixel to be adjusted in red class 1 can be rotated to a position near line1, the pixel to be adjusted in green class 2 is rotated to a position near line2, and the pixel to be adjusted in blue class 3 is rotated to a position near line3. In addition, the rotation manner for the color class can be obtained according to actual calculation. Then, a difference between the third angle value and the fourth angle value is calculated, that is, a rotation angle range in which the pixel to be adjusted can be adjusted is calculated. Then, the difference is multiplied by an adjustment ratio to obtain a third rotation angle value of the pixel to be adjusted in the color class within the rotation angle range, where the adjustment ratio is less than 1. Then, based on the coordinate information (uₚ, vₚ) of the confusion point, the third rotation angle value Δθ3, the fourth angle value θₒᵣ₄ and the third distance value d3, adjusted coordinate information corresponding to the pixel to be adjusted in the color class is calculated. Specifically, the coordinate information (uₚ, vₚ) of the confusion point, the third rotation angle value Δθ3, the fourth angle value θₒᵣ₄ and the third distance value d3 are substituted into adjustment formulas for the pixel to be adjusted, the formulas being u_{new}=uₚ+d3·cos(θₒᵣ₄+Δθ3), and v_{new}=vₚ+d3·sin(θₒᵣ₄+Δθ3), so as to obtain the adjusted coordinate information corresponding to the pixel to be adjusted in the color class. The adjusted coordinate information indicates the adjusted color of the pixel to be adjusted, so as to adjust the color in the original image to the color that can be distinguished by the color-blind user. Therefore, the third color adjustment strategy used to adjust the color of the pixel to be adjusted in the original image is applicable to the original image with complex colors.

It should be noted that the coordinate information of confusion points corresponding to different types of color blindness is different, therefore the preset confusion lines corresponding to different color classes are preset based on the type of color blindness. Therefore, among the types of color blindness, the adjusted coordinate information of the pixel to be adjusted in the third color adjustment strategy is different, that is, the adjustment result of the color of the pixel to be adjusted in the original image is different. That is, the third color adjustment strategy is determined based on the color blindness type, so as to allow different color-blind users to recognize the original image.

In some embodiments, the preset color adjustment strategy includes a fourth color adjustment strategy. The fourth color adjustment strategy is an RGB space color compensation strategy. The fourth color adjustment strategy is obtained through the following method. To be specific, an electronic device obtains a color blindness type of a color-blind user, obtains, based on the color blindness type, first color information corresponding to the original image received by the color blind user and second color information lost by the color-blind user in the original image. The second color information can be calculated based on the first color information of the original image. That is, after an LMS coordinate processing is performed on the first color information, the second color information can be obtained. Then, color compensation information can be obtained based on the first color information and the second color information. The color compensation information is the difference between the first color information and the second color information. Each pixel to be adjusted in the original image can be adjusted based on the color compensation information. For example, for a red-blind patient, the red component in the color compensation information is converted onto the blue component and the green component, i.e., the red component is zero. Then, a sum of the first color information of the original image and the adjusted color compensation information of each pixel to be adjusted in the original image is calculated to obtain the adjusted color information corresponding to the pixel to be adjusted. Therefore, the fourth color adjustment strategy determined based on the type of color blindness is used to adjust the color of the pixel to be adjusted in the original image so as to allow different color-blind users to distinguish the original image, and is applicable to the original image with complex colors.

It should be noted that color-blind patients can choose different modes and adjustment strengths according to their own needs to obtain the adjustment manners that best meets their own requirements.

In some embodiments, the obtaining the pixel statistical information of the original image includes obtaining at least one of a histogram of the original image in RGB space and a histogram of the original image in Luv space, coordinates and a range of landing points of pixels of the original image in the Luv space, or a clustering result of the landing points of the pixels of the original image in the Luv space, so as to adjust the original image based on the pixel statistical information.

In some embodiments, the target color adjustment strategy is determined by the following steps. Specifically, a color distribution scene of the original image is determined based on pixel statistical information. That is, a color distribution in the original image is determined based on coordinates and ranges of landing points of pixels of the original image in the Luv space, a color distribution of red, blue and green in the original image. Weights of different preset color adjustment strategies are determined based on the color distribution scene. That is, for different color distributions in the original image, proportions of different preset color adjustment strategies in all preset color adjustment strategies are changed, and then the target color adjustment strategy is calculated based on the weights and the preset color adjustment strategies, and the original image is adjusted based on the target color adjustment strategy. Therefore, in the present disclosure, the target color adjustment strategy formed by different preset color adjustment strategies is used to adjust the original image, so that the colors in the original image can be distinguished by the color-blind user, and the color change in the original image is small so as to improve the naturalness of the original image. In addition, the corresponding weights of different preset color adjustment strategies can also be set according to the actual display effect and actual needs.

In the embodiment, the landing point clustering can be carried out by automatic clustering, and the color distribution scene can be determined based on the position of each class and the distance between classes.

In some embodiments, the determining the weight of the preset color adjustment strategy based on the color distribution scene includes: obtaining coordinate information of landing points of pixels in the original image in the Luv space; determining a color gamut area of the Luv space and the number of landing points for different color types; calculating a landing area based on the coordinate information of the landing points; determining an image color distribution based on the landing area and the color gamut area; and determining the weight of the preset color adjustment strategy based on the image color distribution or the number of landing points.

Specifically, the first preset color adjustment strategy is mainly used for a proportion of blue in the image, the second color adjustment strategy is mainly suitable for a situation where the area of landing points in the Luv space accounts for a small proportion of the entire color gamut and the boundaries between color classes are clear, the third color adjustment strategy is mainly suitable for a situation where the area of the landing points accounts for a large proportion of the entire color gamut, and the fourth color adjustment strategy is mainly suitable for a situation where the area of the landing points accounts for a very large proportion of the entire color gamut. Based on this, an electronic device obtains coordinate information of landing points of pixels of the original image in the Luv space, and determines a color gamut area corresponding to a display screen of the electronic device in the Luv space and the number of landing points of different color types. That is, the number of landing points that fall into different color types is counted to obtain the number of the landing points of different color types. Then, based on the coordinate information of the landing points, the area of the landing points is calculated. That is, a standard deviation of all landing points in the original image is calculated. For example, the area of the landing points in the u direction is represented as 6u_σ, or the area of the landing points in the v direction is represented as 6v_σ or v_{σ}*u_σ. In addition, the area of landing points can alternatively be calculated by range. Then, an image color distribution is determined based on the area of landing points and the color gamut area. That is to say, the weight of the preset color adjustment strategy is determined based on the image color distribution or the number of landing points. Therefore, for different color distribution situations in the original image, the weight of the preset color adjustment strategy is set so as to perform color adjustment in different degrees, so that the original image has good discrimination in different color distribution scenes. The weight is any value within the range of 0 to 1. For example, the weight corresponding to each preset color adjustment strategy is determined by the ratio of the area of landing points to the color gamut area. Here, u_σ and v_σ are calculated by the following formulas of

$$\begin{matrix}u\_σ = \sqrt{\frac{{\sum }_{i = 1}^{n} {( {u}_{i} - u\_avg )}^{2}}{n}} \\ v\_σ = \sqrt{\frac{{\sum }_{i = 1}^{n} {( {v}_{i} - v\_avg )}^{2}}{n}} \\ \begin{matrix}u\_avg = \frac{1}{n} * {\sum }_{i = 1}^{n} {u}_{i} , & v\_avg = \frac{1}{n} * {\sum }_{i = 1}^{n} {v}_{i} .\end{matrix}\end{matrix}$$

For example, the second color adjustment strategy, the third color adjustment strategy, and the fourth color adjustment strategy are divided into different ranges of the ratio of the area of landing points to the color gamut area. That is, the ratio range corresponding to the second color adjustment strategy is a first ratio range, and the ratio range corresponding to the third color adjustment strategy is a second ratio range, and the ratio range corresponding to the fourth color adjustment strategy is a third ratio range. If the ratio of the area of the landing points to the color gamut area is calculated to be within the first ratio range, the weight of the second color adjustment strategy is set to be larger, or otherwise set to be smaller. If the ratio of the area of landing points and the color gamut area is calculated to be within the second ratio range, the weight of the third color adjustment strategy is set to be larger, or otherwise set to be smaller. If the ratio of the area of landing points to the color gamut is calculated to be within the third ratio range, the weight of the fourth color adjustment strategy is set to be larger, or otherwise set to be smaller.

For example, three confusion lines are pre-set in the u′v′ space to divide all landing points into three color classes, i.e., red, green, and blue. Then, the number of landing points in each of the three color classes is counted to determine a proportion of landing points in the blue class to all the landing points in all color classes. When the proportion is larger, the weight of the first color adjustment strategy is smaller.

In some embodiments, the target color adjustment strategy is obtained based on the weight and the preset color adjustment strategy. Specifically, a result obtained after adjusting pixels in the original image based on the preset color adjustment strategy is multiplied with the weight corresponding to the preset color adjustment strategy. For example, if the ratio of the area of landing points to the color gamut area is calculated as being within the first ratio range, the weight corresponding to the second color adjustment strategy is 0.4 and the second color adjustment strategy is used to adjust the color of the pixel to be adjusted in the original image to obtain the result adj₂ after adjustment by the second color adjustment strategy, the weight corresponding to the third color adjustment strategy is 0.2 and the third color adjustment strategy is used to adjust the color of the pixel to be adjusted in the original image to obtain the result adj₃ after adjustment by the third color adjustment strategy, the weight corresponding to the fourth color adjustment strategy is 0.2 and the fourth color adjustment strategy is used to adjust the color of the pixel to be adjusted in the original image to obtain the result adj₄ after adjustment by the fourth color adjustment strategy, the weight corresponding to the first color adjustment strategy is 0.2 and the first color adjustment strategy is used to adjust the color of the pixel to be adjusted in the original image to obtain the result adj₁ after adjustment by the first color adjustment strategy adjustment. Then, the result obtained after adjustment by each of the preset color adjustment strategies is multiplied by the weight w corresponding to the preset color adjustment strategy, and a sum of these results obtained after the multiplication is taken as the target color adjustment strategy color_adj, which can be represented as: color_{adj}=w₁*adj₁+w₂*adj₂+w₃*adj₃+w₄*adj₄,

Where adj=f_{adj2}(input_{img}), and input_{img} is the original image.

In addition, the image correction strategy in the present application is applicable to all degrees of patients with red color blindness, green color blindness or blue color blindness. Color-blind users can set color correction types according to their own needs, that is, setting different preset color adjustment strategies corresponding to the correction weight and the overall correction intensity, so that the final image presentation effect is more suited to their own preferences.

In some embodiments, since the colors of pixels in the same class in the original image are very similar, the brightness values of pixels in the original image are adjusted to allow different colors with the same brightness in a class to be distinguished. The electronic device obtains a clustering result of landing points of pixels of the original image in the Luv space. For example, the electronic device uses an automatic clustering algorithm such as k-means clustering algorithm to cluster the colors of the original image, in order to obtain a clustering result of the landing points of the pixels of the original image in the Luv space. The clustering result can be divided into three clusters: blue, red, and green. Brightness values of different colors in each cluster are calculated based on the clustering result. The brightness value corresponding to a pixel is represented by L in the coordinate information of the Luv space, or the brightness value of a pixel is obtained by weighting each of the three RGB channels in a certain proportion. The brightness values of different colors within each cluster are compared, and then the brightness of pixels in each cluster is adjusted based on the brightness values to enhance the contrast of brightness of different colors in the cluster, so that color-blind users can distinguish the colors within the same cluster.

In addition, brightness adjustment can be made to pixels in each of color classes into which landing points are divided based on the color hue, to enhance the brightness contrast of different colors within the cluster, so as to allow color-blind users to distinguish among colors within the same cluster. In the present application, color adjustment is applied between classes, aiming to make different classes in different confusion lines, while brightness adjustment is applied within a class, aiming to distinguish among different colors in the same brightness within the class. In addition, changes in color and in brightness are obtained through statistical information from a single frame image. Color adjustment is performed in the u′v′ plane of CIE1976 Luv color space, and brightness adjustment is performed on the L-axis of the Lu′v′ space.

In some embodiments, the brightness of pixels within each cluster is adjusted based on the brightness values. That is, a degree of difference between different colors within a cluster is determined based on brightness values of the different colors within the cluster, and then a brightness adjustment amount is determined based on the degree of difference. That is, if the degree of difference between different colors within the cluster is small, a larger brightness adjustment amount is used to increase the degree of difference between different colors within the cluster. Then, the brightness values of corresponding pixels are adjusted based on the brightness adjustment amount. For example, the brightness value of a pixel is increased or decreased, that is, the brightness adjustment amount has a positive or negative value. The larger the brightness value of a pixel before adjustment is, the larger of the brightness value of the pixel after adjustment is. Conversely, the smaller the brightness value of a pixel before adjustment is, the smaller the brightness value of the pixel after adjustment is. In this way, it can improve the brightness contrast of different colors within the cluster, and improve the distinction of different colors is increased, so as to allow color-blind users can distinguish among colors in the same cluster. In addition, if there is a significant difference in colors within each cluster, there is no need to adjust the brightness of the pixels within the cluster.

In some embodiments, when an electronic device plays a video through a video signal, the video playing needs to be real-time and continuous. The electronic device determines whether the color distribution scene has changed based on pixel statistical information of a current video frame and pixel statistical information of a previous video frame, i.e., pixel statistical information of multiple frames including the current video frame and the previous video frame, so as to determine an image correction strategy of the current video frame, thereby improving the real time and continuity of video playing. Here, the term “previous video frame” may refer to several previous video frames or one immediately previous video frame. The histograms of the original image in RGB space and Luv space are used to obtain the pixel statistical information of a current video frame and the pixel statistical information of a previous video frame (i.e., pixel statistical information of multiple frames), that is, to obtain the pixel value changes of the current video frame and the previous video frame. Then it is determined whether the color distribution scene has changed based on the pixel statistical information of the multiple frames. That is, it is determined whether the brightness and colors of the original image have changed based on the pixel statistical information of the multiple frames. If the color distribution scene changes, the image correction strategy of the current video frame is adjusted based on the color distribution scene and the image correction strategy of the previous video frame. The image correction strategy includes a color adjustment strategy and a brightness adjustment strategy. That is, the image correction strategy of the current video frame is recalculated based on the color distribution scene and the previous video frame, so as to improve the real time and continuity of the video playing. Moreover, the image correction strategy of the current video frame being calculated based on the previous video frame can achieve smooth transitions between frames and avoid the problem of video frame flickering. In addition, if the color distribution scene does not change, the image correction strategy corresponding to the previous video frame is used as the image correction strategy of the current video frame.

In some embodiments, adjusting the image correction strategy of the current video frame based on the image correction strategy of the previous video frame comprises includes: obtaining an average value of an absolute difference between an pixel value of each pixel in the current video frame and an pixel value of the corresponding pixel in the previous video frame to obtain a difference value of the color distribution scene due to change thereof, and then obtaining a reference weight of the image correction strategy of the previous video frame based on the difference value. However, the larger the difference value is, the greater the change of the current video frame relative to the previous video frame is, and the previous video frames have a little reference, and thus the reference weight of the image correction strategy of the previous video frame is smaller. Conversely, the smaller the difference value is, the reference weight of the image correction strategy of the previous video frame is larger. Then, an adjusted image correction strategy ADJ_{final} of the current video frame is calculated based on the reference weight k, the image correction strategy ADJₚᵣₑ of the previous video frame and the image correction strategy ADJ_{cur} of the current video frame, where ADJ_{cur} is the image correction strategy calculated based on pixel statistical information, ADJ_{final} is represented as ADJ_{final}=(1−k)*ADJ_{cur}+k*ADJₚᵣₑ. Therefore, in the present disclosure, the image correction strategy of the current video frame is calculated based on the image correction strategy of the previous video frame and the reference weight thereof, so as to improve the real time and continuity of video playing. Furthermore, the image correction strategy of the current video frame being calculated based on the previous video frame can achieve a smooth color transition between frames, avoid the problem of video frame flickering, meet the real time and continuity requirements of the video, reduce computational time, and minimize color changes in the original image that are caused by the image correction strategy so as to enhance the naturalness of the original image.

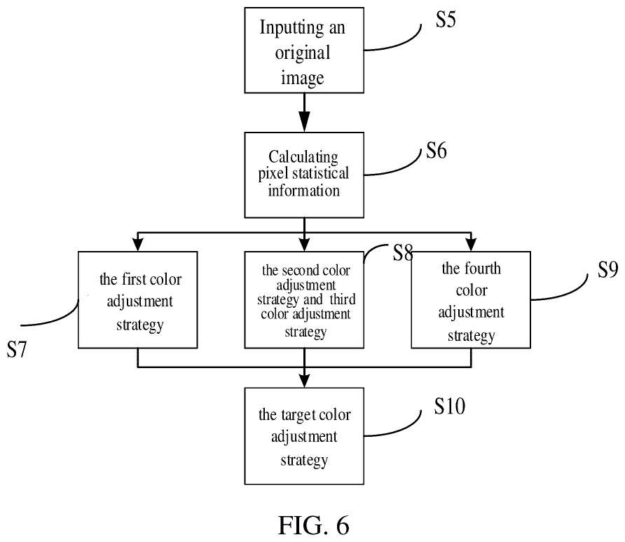

The following is an example of an image correction method in an embodiment of the present disclosure. As shown in FIG. 6, and the specific content is as follows.

At Step S5, an original image is input.

At Step S6, pixel statistical information of the original image is calculated. The pixel statistical information at least includes coordinate information of landing points of pixels of the original image in Luv space. The method proceeds to steps S7, S8, and S9.

At Step S7, a first color adjustment strategy is a strategy of rotating a pixel to be adjusted around a white point W.

At Step S8, a second color adjustment strategy and a third color adjustment strategy both are strategies of rotating a pixel to be adjusted around a confusion point.

At Step S9, a fourth color adjustment strategy is a strategy of RGB space color compensation.

At Step S10, a target color adjustment strategy is obtained based on weights and results corresponding to the first color adjustment strategy, the second color adjustment strategy, the third color adjustment strategy, and the fourth color adjustment strategy.

Therefore, in the present application, the target color adjustment strategy formed based on multiple preset color adjustment strategies is used to adjust an original image, so as to allow colors in the original image can be distinguished by a color-blind user. In addition, the color change in the original image is small, so as to improve the naturalness of the original image.

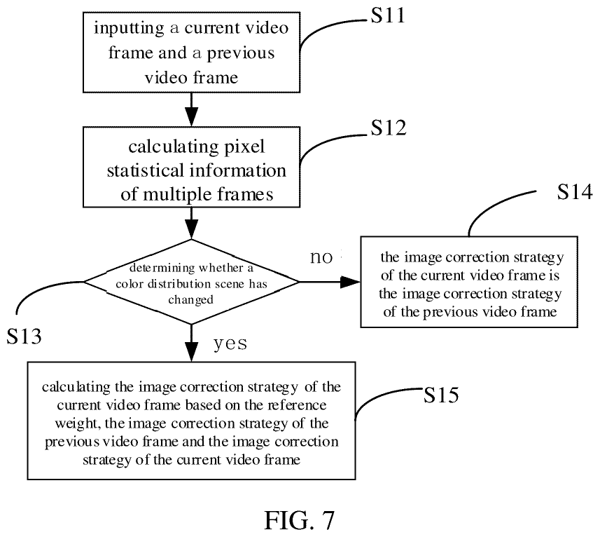

The following is an example of an image correction method in an embodiment of the present disclosure. As shown in FIG. 7, the specific content is as follows.

At Step S11, a current video frame and a previous video frame are input.

At Step S12, pixel statistical information of multiple frames is calculated.

At Step S13, it is determined whether a color distribution scene has changed. If so, the method proceeds to step S15; otherwise, the method proceeds to step S14.

At Step S14, the image correction strategy of the current video frame is adjusted

based on the image correction strategy of the previous video frame.

At Step S15, the image correction strategy ADJ_{final} of the current video frame is calculated based on the reference weight k, the image correction strategy ADJₚᵣₑ of the previous video frame and the image correction strategy ADJ_{cur} of the current video frame, that is, the reference weight k, the image correction strategy ADJₚᵣₑ of the previous video frame, and the image correction strategy ADJ_{cur} of the current video frame are substituted into the formula ADJ_{final}=(1−k)*ADJ_{cur}+k*ADJₚᵣₑ.

Therefore, in the present disclosure, the image correction strategy of the current video frame is recalculated based on the image correction strategy of the previous video frame and the reference weight thereof, so as to improve the real time and continuity of the video playing. Moreover, the image correction strategy of the current video frame being calculated based on the previous video frame can achieve smooth transitions between frames and avoid the problem of video frame flickering.

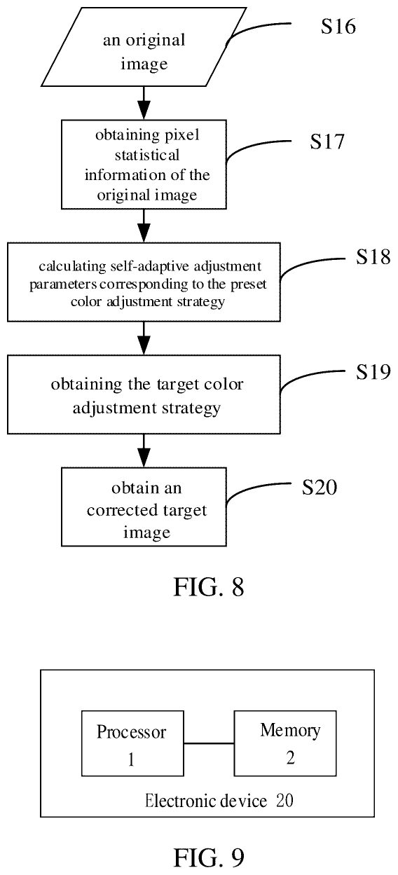

The following is an example of an image correction method in an embodiment of the present disclosure. As shown in FIG. 8, the specific content is as follows.

At Step S16, an original image is input.

At Step S17, pixel statistical information of the original image is obtained.

At Step S18, self-adaptive adjustment parameters corresponding to the preset color adjustment strategy is calculated. That is, a first rotation angle value and a rotation direction corresponding to the first color adjustment strategy, a second rotation angle value and a rotation direction corresponding to the second color adjustment strategy, a preset confusion line, a third rotation angle value and a rotation direction corresponding to the second color adjustment strategy, and a color compensation information corresponding to the fourth color adjustment strategy are calculated.

At Step S19, the target color adjustment strategy is obtained. That is, the weight corresponding to each color adjustment strategy is obtained based on pixel statistical information, and the target color adjustment strategy is obtained based on the weights and results corresponding to the first color adjustment strategy, the second color adjustment strategy, the third color adjustment strategy and the fourth color adjustment strategy.

At Step S20, the color of each pixel in the original image that can not be distinguished by a color-blind user is adjusted based on the target color adjustment strategy to obtain a corrected target image with colors that can be distinguished by users.

Therefore, in the present application, the target color adjustment strategy formed based on multiple preset color adjustment strategies is used to adjust an original image, so as to allow colors in the original image can be distinguished by a color-blind user. In addition, the color change in the original image is small, so as to improve the naturalness of the original image.

An embodiment in a second aspect of the present disclosure provides an electronic device 10. As shown in FIG. 9, the electronic device 10 includes: at least one processor 1 and a memory 2 connected in communication connection with the at least one processor 1.

The memory 2 stores a computer program executable by the at least one processor 1, and the computer program when executed by the at least one processor 1, implements the image correction method according to any of the above embodiments.

The electronic device according to the embodiment of the present disclosure, by performing the image correction method of any embodiment as described above, can adjust an original image using the target color adjustment strategy formed based on multiple preset color adjustment strategies, so as to allow colors in the original image to be distinguished by a color-blind user. In addition, the color change in the original image is small, so as to improve the naturalness of the original image.

An embodiment in a third aspect of the present disclosure provides a computer readable storage medium having a computer program stored thereon. The computer program when executed, implements the image correction method according to any of the embodiments as described above.

In the specification of the disclosure, any process or method described in a flow chart or described herein in other ways may be understood to include one or more modules, segments or portions of codes of executable instructions for achieving specific logical functions or steps in the process, and the scope of a preferred embodiment of the disclosure includes other implementations, which may not be performed in the order shown or discussed, including in a substantially simultaneous manner or in a reverse order according to involved functions, and should be understood by those skilled in the art to which embodiments of the present disclosure belong.

The logic and/or step described shown in the flow chart or in other manners herein, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium include but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the disclosure may be achieved by commanding the related hardware with programs. The programs may be stored in a computer readable storage medium, and the programs comprise one or a combination of the steps in the method embodiments of the disclosure when run on a computer.

In addition, each function cell of the embodiments of the disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks or CD, etc. Although the embodiments of the disclosure have been shown and described above, it should be understood that the above embodiments are exemplary and should not be construed as limiting the disclosure. Those skilled in the art may change, modify, and substitute the embodiments within the scope of the disclosure.

Reference throughout this specification to terms such as “an embodiment”, “some embodiments”, “exemplary embodiment”, “an example”, “a specific example”, or “some examples”, means that a particular feature, structure, material, or characteristic described in connection with the embodiment or example is included in at least one embodiment or example of the disclosure. Thus, in the present disclosure, the schematic expressions of the above terms are not necessarily referring to the same embodiment or example of the disclosure.

Although embodiments of the present disclosure have been shown and described, it would be appreciated by those skilled in the art that changes, alternatives, and modifications can be made in the embodiments without departing from spirit and principles of the disclosure. The protection scope of the present disclosure is defined by claims and equivalents thereof.

What is claimed is:

1. An image correction method, comprising:
obtaining an original image and a preset color adjustment strategy;
obtaining pixel statistical information of the original image;
determining a target color adjustment strategy based on the pixel statistical information and the preset color adjustment strategy; and
adjusting the original image based on the target color adjustment strategy to obtain a target image with colors distinguishable by a user.

2. The image correction method according to claim 1, wherein the preset color adjustment strategy comprises a first color adjustment strategy, the first color adjustment strategy is obtained by:
obtaining coordinate information of a white point in u′v′ space, coordinate information of a pixel to be adjusted in the original image, and a first rotation angle value of the pixel to be adjusted;
obtaining, based on the coordinate information of the white point and the coordinate information of the pixel to be adjusted, a first angle value between the pixel to be adjusted and the white point, as well as a first distance value between the pixel to be adjusted and the white point; and
obtaining adjusted coordinate information corresponding to the pixel to be adjusted in the original image based on the coordinate information of the white point, the first rotation angle value, the first angle value and the first distance value.

3. The image correction method according to claim 1, wherein the preset color adjustment strategy comprises a second color adjustment strategy, the second color adjustment strategy is obtained by:
performing color clustering on the original image to obtain a color class of pixels in the original image;
obtaining coordinate information of a confusion point in u′v′ space, coordinate information of a pixel to be adjusted in each color class, and a second rotation angle value of the pixel to be adjusted;
obtaining a second angle value of the pixel to be adjusted with respect to the confusion point and a second distance value from the pixel to be adjusted to the confusion point based on the coordinate information of the confusion point and the coordinate information of the pixel to be adjusted; and
obtaining adjusted coordinate information corresponding to the pixel to be adjusted based on the coordinate information of the confusion point, the second rotation angle value, the second angle value, and the second distance value.

4. The image correction method according to claim 1, wherein the preset color adjustment strategy comprises a third color adjustment strategy, the third color adjustment strategy is obtained by:
obtaining a landing point of a pixel to be adjusted in the original image in u′v′ space;
performing, based on color hue, color classification on the landing point to obtain a color class;
obtaining coordinate information of a confusion point in u′v′ space, coordinate information of the pixel to be adjusted in each color class, and a third angle value of a preset confusion line corresponding to the color class in u′v′ space;
obtaining a fourth angle value of the pixel to be adjusted in the color class with respect to the confusion point based on the coordinate information of the confusion point and the coordinate information of the pixel to be adjusted in the color class;
obtaining a third rotation angle value of the pixel to be adjusted in the color class based on the third angle value and the fourth angle value; and
obtaining adjusted coordinate information corresponding to the pixel to be adjusted in the color class based on the coordinate information of the confusion point, the third rotation angle value, the third angle value and the third distance value.

5. The image correction method according to claim 1, wherein the preset color adjustment strategy comprises a fourth color adjustment strategy, the fourth color adjustment strategy is obtained by:
obtaining a color blindness type of a color-blind user;
obtaining, based on the color blindness type, first color information corresponding to the original image received by the color-blind user and second color information lost by the color-blind user in the original image;
obtaining color compensation information based on the first color information and the second color information; and
adjusting each pixel to be adjusted in the original image based on the color compensation information to obtain adjusted color information corresponding to the pixel to be adjusted.

6. The image correction method according to claim 1, wherein said obtaining the pixel statistical information of the original image comprises: obtaining at least one of:
a histogram of the original image in RGB space and a histogram of the original image in Luv space,
coordinates and ranges of landing points of pixels of the original image in the Luv space, or
a clustering result of the landing points of the pixels of the original image in the Luv space.

7. The image correction method according to claim 6, wherein said determining the target color adjustment strategy based on the pixel statistical information and the preset color adjustment strategy comprises:
determining a color distribution scene of the original image based on the pixel statistical information;
determining a weight of the preset color adjustment strategy based on the color distribution scene; and
obtaining the target color adjustment strategy based on the weight and the preset color adjustment strategy.

8. The image correction method according to claim 7, wherein said determining the weight of the preset color adjustment strategy based on the color distribution scene comprises:
obtaining coordinate information of landing points of pixels in the original image in the Luv space;
determining a color gamut area of the Luv space and the number of landing points for different color types;
calculating an area of the landing points based on the coordinate information of the landing points;
determining an image color distribution based on the area of the landing points and the color gamut area; and
determining the weight of the preset color adjustment strategy based on the image color distribution or the number of landing points.

9. The image correction method according to claim 8, wherein said obtaining the target color adjustment strategy based on the weight and the preset color adjustment strategy comprises:
multiplying a result obtained after adjusting pixels in the original image based on the preset color adjustment strategy with the weight corresponding to the preset color adjustment strategy; and
determining a sum value of all the results obtained by the multiplication as the target color adjustment strategy.

10. The image correction method according to claim 7, further comprising:
obtaining a clustering result of the landing points of pixels of the original image in the Luv space;
calculating brightness values of different colors within each cluster based on the clustering result; and
adjusting brightness of pixels within each cluster based on the brightness values.

11. The image correction method according to claim 10, wherein said adjusting the brightness of pixels within each cluster based on the brightness values comprises:
determining a degree of difference between different colors within the cluster based on brightness values of the different colors within the cluster;
determining a brightness adjustment amount based on the degree of difference; and
adjusting the brightness values of corresponding pixels based on the brightness adjustment amount.

12. The image correction method according to claim 11, further comprising:
obtaining pixel statistical information of multiple frames including a current video frame and a previous video frame;
determining whether the color distribution scene has changed based on the pixel statistical information of the multiple frames; and
adjusting, if the color distribution scene changes, an image correction strategy of the current video frame based on the color distribution scene and an image correction strategy of the previous video frame, the image correction strategy comprising a color adjustment strategy and a brightness adjustment strategy.

13. The image correction method according to claim 12, wherein adjusting the image correction strategy of the current video frame based on the image correction strategy of the previous video frame comprises:
obtaining a reference weight of the image correction strategy of the previous video frame based on a difference value of the color distribution scene due to change thereof; and
obtaining an adjusted image correction strategy of the current video frame based on the reference weight, the image correction strategy of the previous video frame, and the image correction strategy of the current video frame.

14. An electronic device, comprising:
at least one processor; and
a memory in communication connection with at least one processor,
wherein the memory stores a computer program executable by the at least one processor, and the at least one processor is configured to perform the computer program to implement the image correction method according to claim 1.

15. The electronic device according to claim 14, wherein the preset color adjustment strategy comprises a first color adjustment strategy, the at least one processor is further configured to perform the computer program to:
obtain coordinate information of a white point in u′v′ space, coordinate information of a pixel to be adjusted in the original image, and a first rotation angle value of the pixel to be adjusted;
obtain, based on the coordinate information of the white point and the coordinate information of the pixel to be adjusted, a first angle value between the pixel to be adjusted and the white point, as well as a first distance value between the pixel to be adjusted and the white point; and
obtain adjusted coordinate information corresponding to the pixel to be adjusted in the original image based on the coordinate information of the white point, the first rotation angle value, the first angle value and the first distance value.

16. The electronic device according to claim 14, wherein the preset color adjustment strategy comprises a second color adjustment strategy, the at least one processor is further configured to perform the computer program to:
perform color clustering on the original image to obtain a color class of pixels in the original image;
obtain coordinate information of a confusion point in u′v′ space, coordinate information of a pixel to be adjusted in each color class, and a second rotation angle value of the pixel to be adjusted;
obtain a second angle value of the pixel to be adjusted with respect to the confusion point and a second distance value from the pixel to be adjusted to the confusion point based on the coordinate information of the confusion point and the coordinate information of the pixel to be adjusted; and
obtain adjusted coordinate information corresponding to the pixel to be adjusted based on the coordinate information of the confusion point, the second rotation angle value, the second angle value, and the second distance value.

17. The electronic device according to claim 14, wherein the preset color adjustment strategy comprises a third color adjustment strategy, the at least one processor is further configured to perform the computer program to:
obtain a landing point of a pixel to be adjusted in the original image in u′v′ space;
perform, based on color hue, color classification on the landing point to obtain a color class;
obtain coordinate information of a confusion point in u′v′ space, coordinate information of the pixel to be adjusted in each color class, and a third angle value of a preset confusion line corresponding to the color class in u′v′ space;
obtain a fourth angle value of the pixel to be adjusted in the color class with respect to the confusion point based on the coordinate information of the confusion point and the coordinate information of the pixel to be adjusted in the color class;
obtain a third rotation angle value of the pixel to be adjusted in the color class based on the third angle value and the fourth angle value; and
obtain adjusted coordinate information corresponding to the pixel to be adjusted in the color class based on the coordinate information of the confusion point, the third rotation angle value, the third angle value and the third distance value.

18. The electronic device according to claim 14, wherein the preset color adjustment strategy comprises a fourth color adjustment strategy, the at least one processor is further configured to perform the computer program to:
obtain a color blindness type of a color-blind user;
obtain, based on the color blindness type, first color information corresponding to the original image received by the color-blind user and second color information lost by the color-blind user in the original image;
obtain color compensation information based on the first color information and the second color information; and
adjust each pixel to be adjusted in the original image based on the color compensation information to obtain adjusted color information corresponding to the pixel to be adjusted.

19. The electronic device according to claim 14, wherein the at least one processor is further configured to perform the computer program to obtaining at least one of:
a histogram of the original image in RGB space and a histogram of the original image in Luv space,
coordinates and ranges of landing points of pixels of the original image in the Luv space, or
a clustering result of the landing points of the pixels of the original image in the Luv space.

20. A computer readable storage medium having a computer program stored thereon, wherein the computer program when executed, implements the image correction method according to claim 1.
